(19) United States
(12) Patent Application Publication
(10) Pub. No.: US 2008/0127296 A1
(43) Pub. Date: May 29, 2008

(54) IDENTITY ASSURANCE METHOD AND SYSTEM

(75) Inventors: Dennis J. Carroll, Houston, TX (US); Clifton E. Grim, Seabrook, TX (US); Christopher I. Schmidt, Friendswood, TX (US); Mark B. Stevens, Austin, TX (US); Gary A. Ward, Seabrook, TX (US); John D. Wilson, Houston, TX (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/564,432

(22) Filed: Nov. 29, 2006

(51) Int. Cl. G06F 21/00

(52) U.S. Cl. 726/1

(57) ABSTRACT

Disclosed are a method of and system for assuring a person's identity. A first party registers with an identity service and gives that service a first set of answers to a set of questions and additional data; the identity service gives the first party identification information; and the first party, through interacting with the identity service, establishes its identity with a second party. To do this, the first party gives the second party the identification information and a second set of answers to the set of questions. The second party sends the identification information and the second set of answers to the identity service. The service analyzes the identification information and the first and second sets of answers to determine an identification quality rating for the first party, and sends that rating to the second party.

### BACKGROUND OF THE INVENTION

1. Field of the Invention

This invention generally relates to identity assurance systems. More specifically, the invention relates to a general identity assurance system that can be used bi-directionally.

2. Background Art

It has always been difficult to ascertain that a person standing in front of you is truly who they claim to be. Unless you have previously met the person in circumstances that assures you of that person's identity or the person gets vouched for by another trusted individual, you have little assurance that the person standing in front of you is really who they say they are, other than fundamental trust.

Society has dealt with this problem over the years by providing the person whose identity may be questioned, a set of identity papers or a badge, ID card, or even a uniform. All of these means are easily compromised, however. There is a need for a system that can easily provide a level of assurance that a person is who he or she says they are.

These requirements span the range of identity assurance from an individual with a plumber at the door to a top-secret military institution needing to deal with outside entities like package delivery personnel.

Recent technology has offered other solutions to assure identity like retinal scans, DNA analysis, fingerprinting, or facial recognition software. These systems work but typically are used by the more powerful partner in the identity exchange. These kinds of systems do not help the common person when he or she is trying to determine in real time that the person who is standing outside their car window is truly who he says he is.

Another vaguely similar solution that has shown up recently uses a “challenge” question scheme to determine whether a person logging onto, for example, a remote banking system should be trusted. In a prior initialization session with the Bank, the person sets up these questions. When the person later tries to logon to the Bank system from a remote and unknown computer, before they are passed through to the system, the untrusted person must answer these “challenge” questions and enter their password.

This system depends on a fixed set of typical questions like “what is your father's middle name”. No facility exists for stronger custom questions. This scheme is only useful for the bank. It is not a bi-directional trust system. It is easier for an institution with robust resources to determine that it can trust an individual than an individual deciding that he can trust another individual or another individual that is a representative of a larger organization. This system is only useful to the bank; it cannot be extended to work for the general populace.

There are certainly other methods that could be used to identify people. A robust system should be capable of taking input from various information sources not just the challenge question scheme to arrive at the decision of whether to trust a person or not.

### SUMMARY OF THE INVENTION

An object of this invention is to provide an identity assurance system.

Another object of the present invention is to address the fundamental issue of assuring a person's identity in real time without the need of having a trusted, vouching individual present.

A further object of the invention is to provide a robust identity assurance system that is capable of taking input from various information sources and that can be used bi-directionally.

These and other objectives are attained with a method of and system for assuring a person's identity. The method comprises the steps of a first party registering with an identity service and giving the identity service a first set of answers to a set of questions and additional identifying data; the identity service giving the first party identification information; and the first party, through interacting with the identity service, establishing its identity with a second party.

In particular, to establish its identity, the first party gives the second party said identification information and a second set of answers to said set of questions. The second party sends said identification information and said second set of answers to the identity service. The identity service analyzes said identification information and compares said first and second sets of answers to determine an identification quality rating for said first party, and sends said identification quality rating to the second party.

If both parties have the ability to connect to the identity service, then to establish its identity the first party give the second party said identification information. The second party sends said identification information to the identity service. The first party then contacts said identity service and sends a second set of answers to the identity service. The identity service analyzes said identification information and compares said first and second sets of answers to determine an identification quality rating for said first party, and sends said identification quality rating to the second party.

The preferred embodiment of the present invention, described in detail below, provides a number of important advantages. For instance, this embodiment of the invention reduces the dependence of the identifier to have specialized equipment or expertise in order to make an identification, and enables the person being identified to use additional means of identification (such as a pin, a password or challenge questions) without having to give this information to the identifier. The invention provides the identifier with the analog identification response giving them a score for the quality of the identification, and provides a method to calculate the quality of the identification. The invention provides a method for allowing the identifier to set the level of identity that needs to be reached, and provides a method for continually challenging the person to be identified for data until an identity quality is reached (i.e. use picture ID, PIN, and challenge questions).

Further benefits and advantages of this invention will become apparent from a consideration of the following detailed description, given with reference to the accompanying drawings, which specify and show preferred embodiments of the invention.

### BRIEF DESCRIPTION OF THE DRAWINGS

FIG. 1 shows a basic overview of the service of the present invention.

FIG. 2 illustrates a first scenario in which the present invention is used, in which a plumber goes to a residence to answer a repair call.

FIG. 3 illustrates a second scenario in which this invention is used, in which the plumber goes to a secure military base to answer a repair call.

FIG. 4 shows a third scenario in which the invention is used, in which a package is delivered to a business during the day.

FIG. 5 shows a fourth scenario in which the invention is used, in which a package is delivered to a business at night.

FIG. 6 provides a more detailed overview of the identity service system of this invention.

FIG. 7 shows an identity service—identify a party with one connection.

FIG. 8 illustrates a basic authentication flow.

FIG. 9 shows a procedure for registering an account (individual) flow.

FIG. 10 shows a procedure for registering an account (child) flow.

FIG. 11 shows a procedure for registering an account (automated device) flow.

FIG. 12 depicts a procedure for registering an account (groups) flow.

### DETAILED DESCRIPTION OF THE PREFERRED EMBODIMENTS

Many activities in today's society are governed by trust. Daily decisions about what to do or not to do are based on trust, whether in a person or an organization. Relationships are based on an individual's personal network of contacts and trusted organizations.

An individual's personal network consists of both direct and indirect relationships. This leads to the idea of “analog trust”. If we only consider trust in the “digital” sense, then we either trust someone or do not trust them. In reality there are levels of trust. For example, you might trust your neighbor to pick up your child from school while you are out of town. You would not, however, trust your neighbor's co-worker's son (who you do not know directly) to pick up your child from school. You would trust the son to pick up the paper from your yard, though (because the amount of trust from the indirect relationship meets your requirement for that task).

Another type of trust is organizational trust, where an organization such as a company or government entity receives trust. One of the challenges for organizational trust is identity. One can trust a delivery company or a police department, but how does one know that the person at the door is actually a legitimate delivery person or police officer? One can check with the Better Business Bureau to find out what the trust level should be for a certain company and then would need to combine this with the ability to identify someone as part of the company.

This problem ties identity and trust very closely. If one can trust an organization, then one can only trust someone from that organization if one can identify them as a member of that organization. In this case, “digital” identity would be the best method, indicating that one could determine absolutely whether this person is a member of the organization. However, when taking into account all of the skills, time, expertise, infrastructure, and expense of determining absolutely, it is not practical for most applications. The idea of “analog trust” can be extended to include “analog identity”; in this way, one can prove someone's identity to the level that is needed to reach the trust threshold for a certain activity. If one can identify someone as “probably” being part of an organization versus identifying them as “absolutely” being part of an organization, then the trust level will be different for what one will allow them to do.

The process of proving identity can include many different factors. Some of these factors can include the need for expertise on the part of the person proving the identity (ability to recognize and verify a picture ID card), specialized infrastructure (a finger print reader), or the ability to communicate sensitive data (password, PIN) without the identifier being able to see the data. All of these factors can restrict the feasibility of generating better identity and thus trust.

The service of the present invention effectively addresses these challenges.

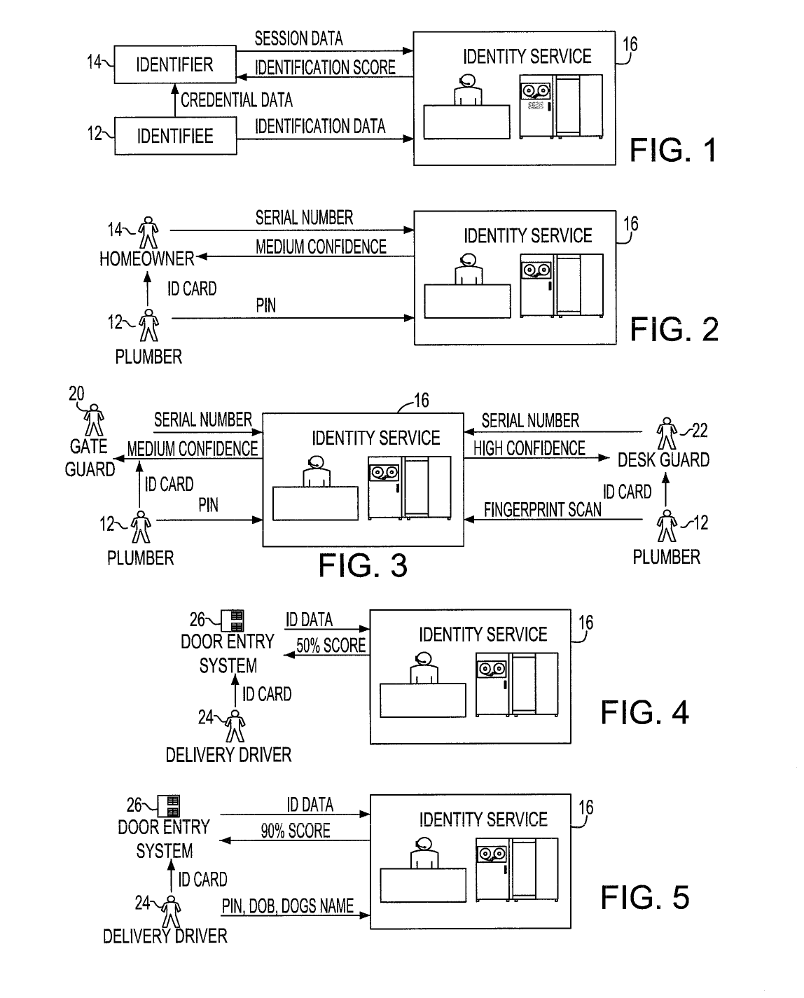

FIG. 1 illustrates a basic overview of the service of the preferred embodiment of the invention. The following scenarios, mapped to this basic overview, describe instances in which the invention is used.

As a first scenario, and with reference to FIGS. 1 and 2, a plumber 12 goes to a residence to answer a repair call. The homeowner 14 answers the door and calls the identification service 16 phone number that the plumbing company previously provided. The plumber also calls the identification service to indicate that he has arrived at the call. The service 16 instructs the homeowner that the plumber will show them a picture ID with the plumber's picture and serial number 4545. The plumber is asked for and enters their personal PIN into the phone. The identification service 16 tells the homeowner 14 that the plumber has responded with the correct PIN and that in combination with correct picture ID, indicates an identification quality of “Medium Confidence”. This level is high enough that the homeowner lets the plumber enter the residence to repair the plumbing problem.

In a second scenario, and with reference now to FIGS. 1 and 3, the plumber 12 goes to a secure military base to answer a repair call. At the gate, represented at 20, the plumber uses his picture ID and PIN to get a “Medium Confidence” level trust in order to drive onto the base. Once he reaches the building that needs the repair, he provides the security desk guard 22 with his picture ID and then uses the security desk's finger print scanner. The security desk system connects to the identification system 16 and asks for verification of the plumber based on his picture ID and fingerprint scan. The identity service 16 checks the data and returns a response of “High Confidence” of trust based on the data provided. The security guard allows the plumber to enter the building and complete the repair.

The previous two scenarios describe the invention being used to identify a plumber. The plumbing company is a registered member of the identification service 16. The plumbing company is also a federal contractor for the military. Given the types of identifications that need to take place, the plumber 12 registered with the identification service as a member of the plumbing company and provided his picture ID card, created a personal PIN, and provided finger print scan information.

As another scenario, illustrated in FIG. 4, a package delivery driver 24 goes to the back door of a business, represented at 26, to deliver a package. It is 10 a.m. and employees are present in the building. The driver 24 uses his company issued ID in the card reader for the back door. The card reader connects to the identification service and sends the ID data for confirmation. The service returns an identification quality rating of 50% based on the quality level of the ID. This meets the current threshold for allowing the driver 24 to enter the door and he leaves the package in the receiving area.

In a second package delivery scenario, and with reference to FIG. 5, during the busy holiday season, a package delivery driver 24 is working late hours to make all of his deliveries. The driver goes to the back door of a business 26 to deliver a package. It is 8 p.m. and there are no employees present in the building. The driver uses his company issued ID in the card reader for the back door. The card reader connects to the identification service 16 and sends the ID data for confirmation. The service 16 returns an identification quality rating of 50% based on the quality level of the ID. This does not meet the nighttime threshold to allow the driver to enter the door. The driver 24 then calls the identification service and provides the identifier for the door he is trying to enter. The identification service links the session and challenges the driver for his PIN, DOB, and name of his dog. Upon receipt of the correct answers, the identification service 16 sends the door an identification quality rating of 90% based on the quality level of the ID and the correct responses to the challenge questions. This meets the nighttime threshold for the door, so it opens and the driver leaves the package in the receiving area.

The previous two scenarios describe the invention being used to identify a package delivery driver. The delivery company and the business that is being delivered to are both members of the identification service. The card reader for the door knows how to interface with the identification service and can process the identification quality responses. The delivery company provided the identification service with the data from their company issued ID cards as well as description of the cards that was used to create the identification quality rating. The driver registered with the identification service as an employee of the delivery company and provided information for PIN, DOB, and personal information challenge questions.

The preferred embodiment of the invention uses a secure data vault, for example as described in copending application Ser. No. 10/965,592, filed Oct. 14, 2004, for “Secure Information Vault, Exchange And Processing system And Method, and copending application Ser. No. 11/082,489, filed Mar. 17, 2005, for “System And Method To Strengthen Advertiser And Consumer Affinity, the disclosures of which are hereby incorporated herein by reference in their entireties. Clients access business logic within the service via secure communication. In the simplest of terms, the service identifies users of the system such that other users of the system have a reasonable confidence that the user is actually who it says it is. An example would be the identification of a Police Officer in a manner that another user of the system would be able to trust that the person is actually a Police Officer. Yet, identifying a person just as a ‘Police Officer,’ is problematic. People regularly assume different responsibilities. During one portion of the day, the Police Officer is on duty and represents his police district. However, at a different time of the day, the person is only a citizen. To solve this, the Identification Service uses a hierarchical system for determining identity, allowing identification data to be shared without having to duplicate it. The system does not limit itself solely to people as well, instead, it identifies Entities.

An Entity is a construct representing a user of the system. An Entity is defined as: an individual person, a group or organizational body, an automated device capable of initiating identification sessions without external guidance, or a child of an Entity. All information for identifying the Entity is stored in an account created within the Identification Service's database. Entities can be independent of others or children of other Entities. There is no limit to the number of parent Entities a child can inherit from, nor is there a limit to the depth of the hierarchy created. Children can inherit some or all data from parent Entities, which in turn can also inherit data from their parent Entities. This allows Identity sessions to identify an Entity as a part of any parent entity as well as itself (i.e. the Police Officer could be identified as a member of his police department or just as himself). The hierarchy allows users of the service to specify exactly how they want to identify other users.

In order to identify an Entity, information about the Entity must be known before an Identity Session begins. Some information defined for an Entity can assure identification better than others. For instance, biometric information about a person has a higher ability to identify him or her than the knowledge of their Social Security number. Thus, each point of data for an Entity has an associated value that indicates the data's relative worth during an Identity Session. The service defines a set of information the Entities can provide for use during Identity Sessions. This can include, but is not limited to, SSN for individuals, Federal Tax ID for companies, biometric information, and driver's license number with issuing state. The service also allows the Entity to define custom information to be used during a session. Since the service cannot judge the value of the information defined by an Entity, custom information will always have a lower intrinsic value than the predefined information. Entities use this information to engage in Identification Sessions to determine a level of trust that an Entity is what it states itself as. Level of trust is a term to describe a number represented as a percentage. This is known as a confidence percentage. 0% indicates that there is no level of trust and 100% indicates that the Entity is known without a doubt.

In order to securely determine a level of trust, the Entities involved in an Identity Session must use an authorized device to facilitate the session. In the case of human Entities, a device must be used that is trusted by all parties to input challenge responses into. For automated Entities, the Entity itself must meet the requirements for a device. The device communicates securely with the Identification Service over a network. The secure medium can be any of the secure protocols currently in use, including SSL transmission over a TCP/IP network. The device will communicate with other Identification devices, primarily for swapping public keys, but can share other information if an Identification Session warrants additional data. The device shall display challenge questions from the Identification Service and allow the Entity to respond to the questions. I.e. the device provides some level of I/O. It also must be able to input additional information if required by the Entity like a magstripe reader for Entities that must swipe a badge or driver's license. The device will also store nothing other than the Entity's public and private key.

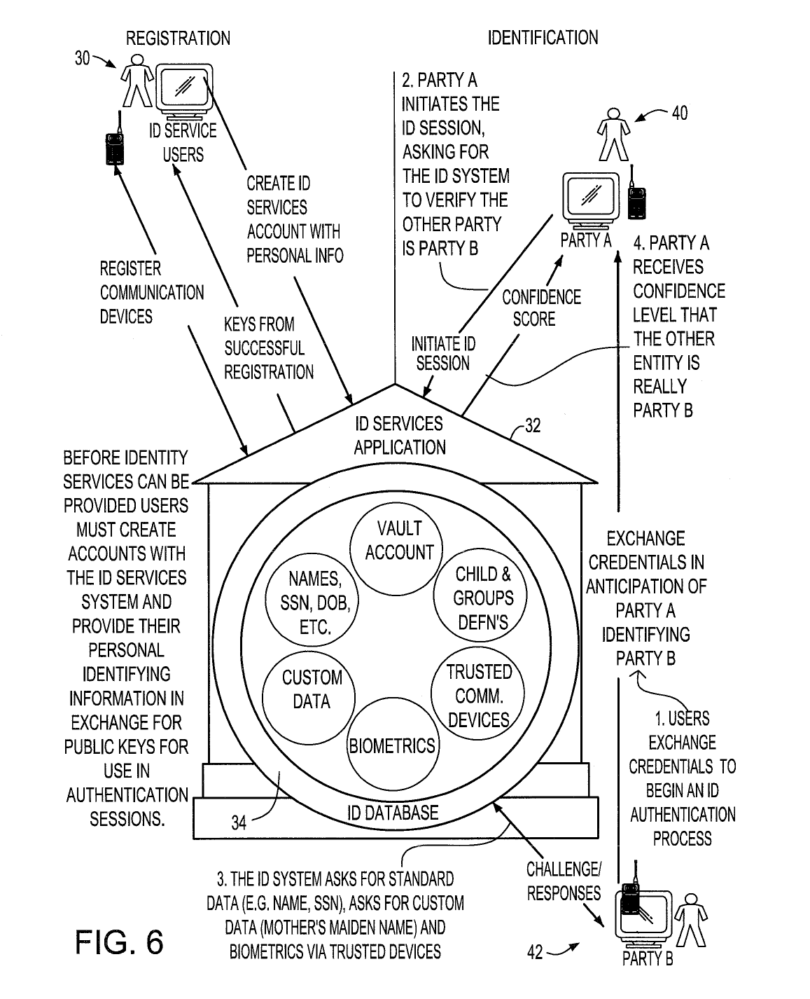

FIG. 6 depicts an Identity Services system 30 in accordance with a preferred embodiment of the invention. Generally, this system includes an identification service application 32, an identification database 34, an Internet interface, and a device interface. Generally, the Identification Service Application provides all of the business functionality to manage the user accounts, provides services to the GUI layer, send/receive information from identification service devices, and manages the identification process. The identification database is a secure database that holds all of the account records and the challenge questions for the users. A secure vault, for example as described in the above-mentioned copending applications Ser. No. 10/965,592 “Secure Information Vault, Exchange And Processing system And Method, and copending application Ser. No. 11/082,489, for “System And Method To Strengthen Advertiser And Consumer Affinity, can be used for the identification database. The Internet interface is a GUI interface, allowing users to customize their account information. The Device Interface authorizes Service devices users to request and receive data during identification sessions.

The service uses a confidence level to communicate trust. The confidence level is defined as a percentage from 0% to 100%. This allows for easy understanding of the different levels as well as being flexible in allowing for detailed calculations to determine trust. Additionally the confidence level can be mapped to “Confidence Categories” that can be easily understood by users. The proposed categories are listed below but could also be changed to apply to a specific user community or usage (easy to do since they are implemented on top of the Confidence level).

0-10% Confidence Category: No Confidence of Trust

11%-60% Confidence Category: Low Confidence of Trust

61%-84% Confidence Category: Medium Confidence of Trust

85%-99% Confidence Category: High Confidence of Trust

100% Confidence Category: Assured Trust

There are multiple ways that the confidence level can be determined, ranging from a simple average (50% confidence value from 2 of 4 challenges answered correctly) to more sophisticated calculations based on the value of each challenge question. One proposed method is to use statistical hypothesis testing to know that a given user will answer at or above the required confidence level with a certain margin for error. An advantage of using this method is that the user does not need to be asked all questions to attain a specific confidence level. The equation used is:

$$t = \frac{\overline{x} - {μ}_{0}}{\frac{σ}{\sqrt{n}}}$$

The hypothesis is that the percentage of answer to failure response is expected to be μ₀ which falls between 0 and 1. This corresponds to the confidence score of 0% to 100%. The system tests against the actual observed mean being less than the expected value using the calculation above. Each time a challenge question is asked, the system will compute the confidence score. As more questions are asked, the error rate of where the actual mean will be gets smaller. Once the error rate is within a certain threshold (i.e. ±1%), the system will stop issuing challenge questions and transmit the confidence score. Since some data have a better likelihood of identifying a person than other data, those data elements are weighted higher than the others. For instance, one data element could be considered as four correct answers if answered properly whereas a different data element would only be considered as one correct answer. This allows biometric and other ‘strong’ identification methods to hold more significance than answering a simple question.

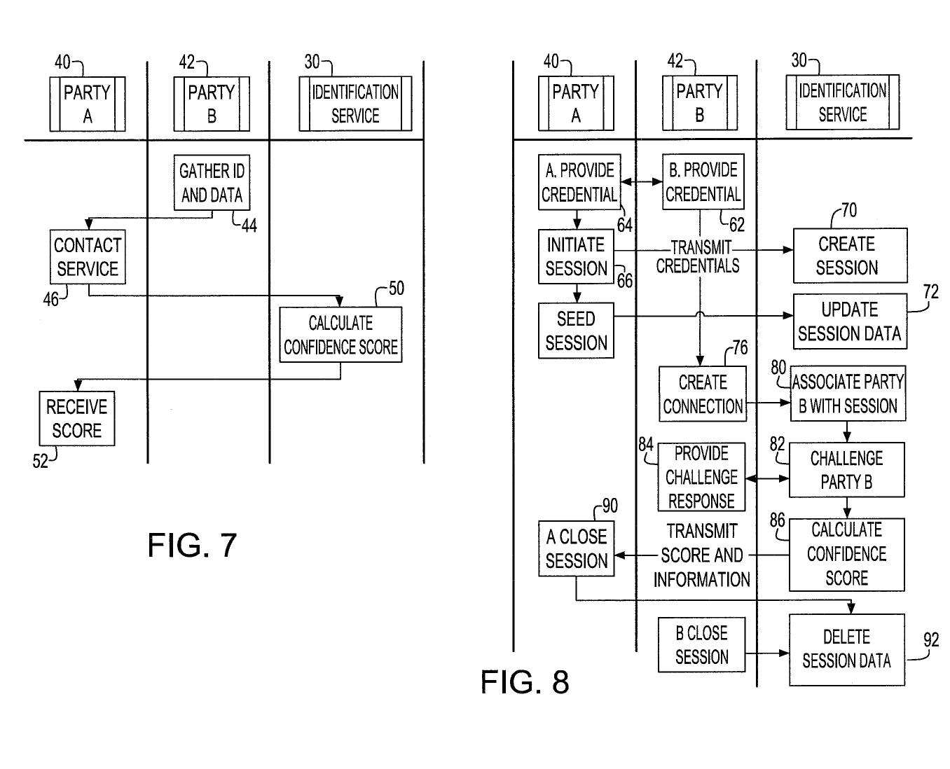

As a first session, consider a situation in which a first party 40 wishes to determine, with a certain degree of assurance, the identity of a second party 42 (Party A and Party B, respectively, in this flow). With reference to FIG. 7, in this session only one connection is needed to request identity assurance. Party B, at 44, gives Party A their unique identifier as well as other identification data. Party A, at 46, passes this information to the Identity Service 30 and the Trust Calculation is done at 50 and a trust level is then returned to Party A at 52 who can decide how to continue based on the confidence level returned.

This realization of the system has both benefits and shortcomings. The benefit of this system is that only Party A requires a connection to the service. Even though bandwidth, cell phones, and communications are becoming more pervasive, in many cases where this system would be used only one party would have connectivity to contact the service. This would most likely occur because one of the parties would tend to be geographically located in the same place and other parties would come to it for identity.

The shortcoming of this realization is that Party B has to give their Identity information to Party A. This could lead to fraud and lessen confidence in the service since it would be easy for Party A to know some of the identify information of Party B. This invention also improves upon itself to overcome this shortcoming when two connections are available.

As another basic scenario, also consider a situation in which a first party wishes to determine, with a certain degree of assurance, the identity of a second party (Party A and Party B, respectively, in this flow). With reference to FIG. 8, in this session, Party B at 62 transfers credentials to Party A by some method. This can be via Bluetooth if the Parties are in close proximity, email if over the Internet, physical if an ID card, etc. This credential can be anything in the set of data that identifies Party B. At a minimum, the unique identifier of Party B must be given (if secure vault is used, this would be the Party's public key), but could be any set of data that can uniquely identify the user to both Party A and Identification Service. For example Party B's public key (give electronically) or drivers license state and number.

Party A, at 64 and 66, initiates an identification session with the identification service, giving the identifier of self and Party B. Identification service at 70 creates a unique identification session between Party A and Party B. Service retrieves data needed for identity session. The service returns a unique session ID to be given to Party B. Party A specifies the level of trust he/she/it wish Party B to attain. This may include choosing just the level (rank of trust), or choosing additional information (Prove birth date, Social Security Number, GPS location, etc). The specific data may be required for the type of transaction that Party A and B want to do post-identification. At this time, at 72, Party A can provide the service with other input data that was received from Party B.

Party B, at 76, communicates with identification service to establish second connection with the Identification service. The service, at 80, links Party B's unique identifier and session ID with the queue of pending identity sessions to find the session that had been requested with Party B. The service requires both the session ID and unique ID to link the session. The service can search for Party B's public key in the pending session queue. The public key was either provided as part of the credentials in Step 62 or was looked up by the identity service to correspond with the unique identifier provided (i.e. ID card). Identification service, at 82, begins communication with Party B. In a loop 82 and 84, it challenges Party B to answer specific questions. Party B answers each in turn. Service 30 does not indicate success or failure to Party B. The confidence level calculation described earlier is used. When all questions are answered, service 30 at 86 determines what level of trust Party B attained. The confidence level calculation described earlier is used.

Service transmits the level and description of items not answered/verified correctly by Party B to Party A. This would be the confidence level that resulted from the session. The items not answered/verified would be transmitted to Party A only if appropriate and allowed by Party B. For example, the user answered seven out of ten challenge questions correctly or the user failed biometric test. At this 90, Party A can transmit a trust/don't trust to the identity service and quit session, or continue session by switching roles from Party A to Party B (and vice-versa for Party B). The above-described steps can be repeated. If Party A is a human, they can decide to trust Party B's identification even if the Party did not answer the challenge questions 100%. If Party A is an automated system, it will base its trust on predefined criteria of what confidence level is acceptable. Identity service 30 at 92 removes any one-time properties from the system that were used in the session.

### Identity Service—Register an account

Within the context of the Identity Service, entities are treated the same, but registration can cover different sets of information based on their type. All communication with the identification service is encrypted to ensure that information shared between an entity and the service is secure.

### Individual

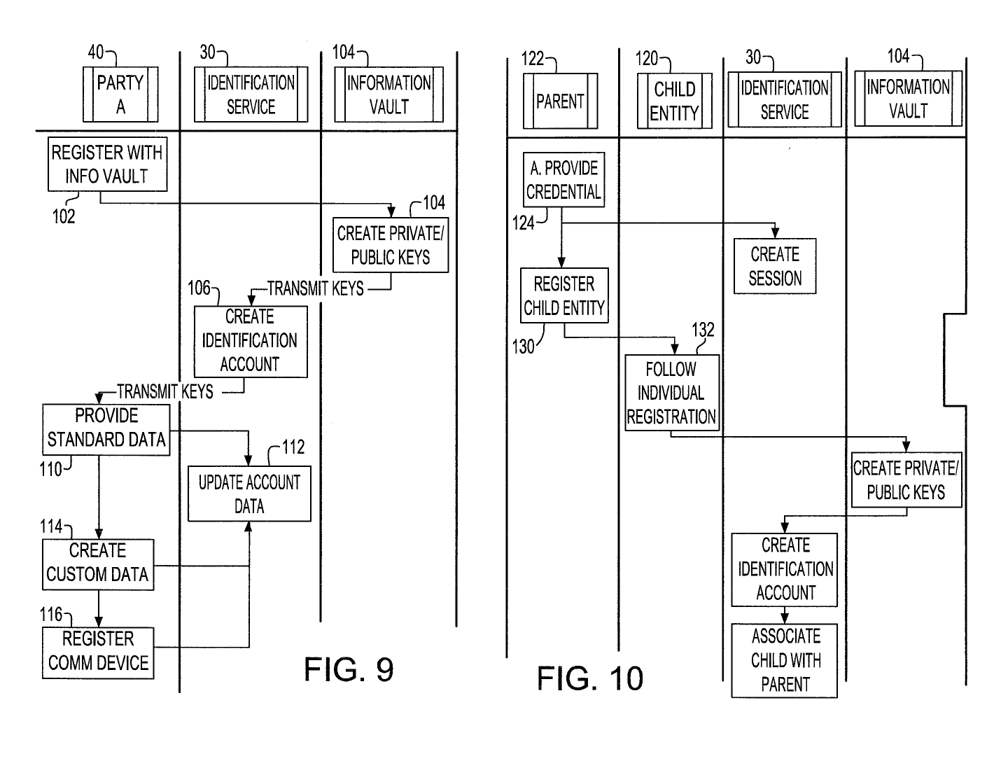

There are three steps to register as an individual with the Identification Service. With reference to FIG. 9, the entity must first register 102 with the secure vault 104 that the Identification Service resides upon. Once the entity is registered with the vault, the entity's public and private key will be known, as represented at 104. The information, as represented at 106, is shared with the Identification Service, and the second phase of registration begins.

The individual, at 110, is presented with the core set of data needed by the Identification Service during the second phase. This may include name, address, social security number, driver's license number, biometric information, etc. The individual, at 112, then has the choice to add new information about himself/herself. This information can include custom challenge questions that only the individual knows the answer to, or information that can be shared with another entity during an identity session like a digitized picture. Since custom information defined by an entity may or may not help identify the user, all custom information, represented at 114, will have a lower value associated with it during the calculation of the Confidence % than the defined information.

The final phase of registration is pairing an approved device with the entity's Identification Service account, represented at 116. The only way to initiate and engage in Identity Sessions is to use a device capable of securely communicating with the Identification Service. This also adds an additional layer of security for an identification session, since a user can only use his associated device to access his account. Any number of devices can be associated with the account, and some devices, like a Personal Computer, can technically be associated with multiple accounts.

When registration is complete, the Identification Service presents the user with the maximum percentage that they can attain via an identity session if all information given is correct. The information given during registration will be unique for each entity. Some individuals may not give a complete set of information, which would hamper the Identification Service when calculating a trust value. By giving the score immediately to the user, the service allows the individual to realize that additional information will be needed if he or she is to attain a particular confidence % during an identity session (business processes may require the individual to attain a particular percentage).

### Child Entry

With reference to FIG. 10, child Entities 120 can act as representatives of their parent(s) 122 or just as themselves during an identity session. A Child Entity can be any other type of entity (Individual, Automated Device, or Group). The parent entity must first register, at 124, with the Identification Service, and the child must have an account in the secure vault. The parent entity then creates a skeleton child entity, at 130, within the Identification Service using the child's public key from the secure vault. All inherited identification information is administered by the parent entity. The parent has the ability to share or restrict any of the parent's attributes when creating the child entity. Attributes allowed for the child will be utilized during an identification session that the child entity participates in.

Once the skeleton account is created, the child entity, at 132, is then responsible for completing the registration process, which follows the standard registration for any of the other entity types.

### Automated Device

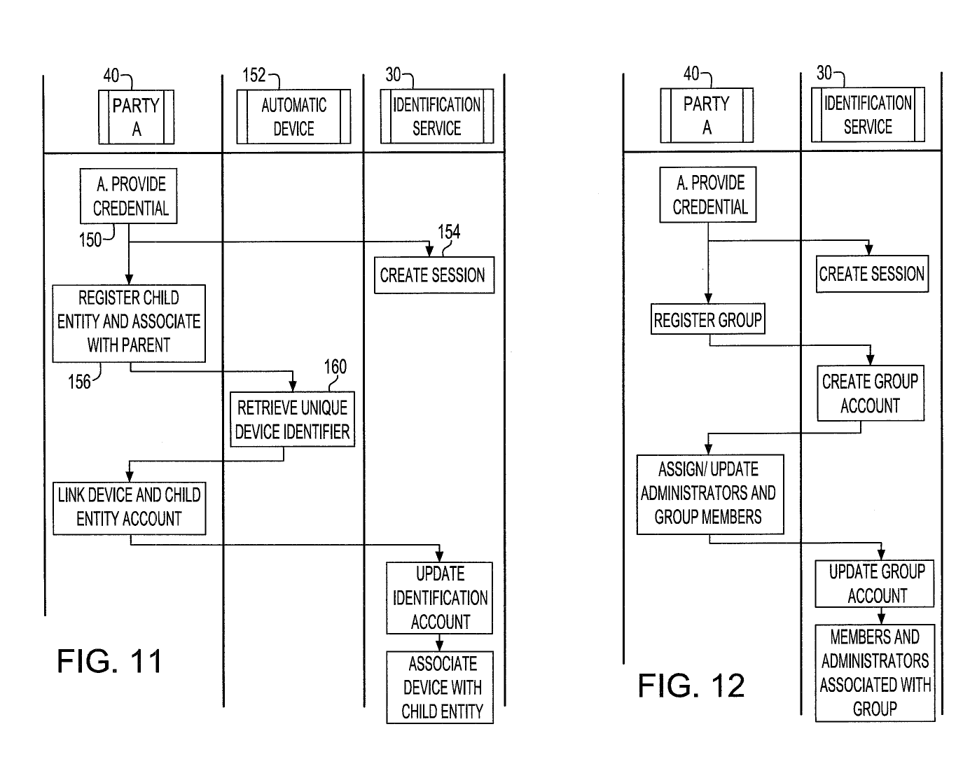

An automated device is always a child entity. It may participate in Identification Sessions without human intervention, but is able to accept input if needed. With reference to FIG. 11, the parent entity, as represented at 150, must have an account registered with the Identification Service prior to registering the automated device 152. The parent can then, at 154 and 156 create the secure vault account and the child account within the Identification Service.

Registration consists of registering the automated device, at 160, with the Identification Service account. This can be as simple as the device's serial number or MAC address. Any identifier that is difficult to spoof and cannot be modified can be used to associate the automated device with its Identification Service account. Additional information will need to be entered for the device during registration that is dependant on the device itself. For example, if the device is stationary and should not move, a GPS location could be given such that Identification Sessions can only be initiated when the device is within a certain distance of the GPC coordinates.

The account is configured to ‘accept’ an Identity Session if the other participant achieves a particular Confidence %. The parent can define multiple configurations for different situations during Identity Sessions. This is useful for cases where an Identity Session has more importance over others. The configurations could include who the other participating entity is (targeted identification for important deliveries), time of day (increased security at night), etc.

### Groups

Groups can be used to logically delineate individuals within the Identification Service. Groups can be parents to Individuals, Automated Devices, or even other Groups. The primary difference between an Individual entity and a Group is the need for administrators within a Group. With reference to FIG. 12, during registration, once the Group has created a secure vault account 172, the Identification Service requires one or more pre-existing Individual entities that will administrate the newly created group. These administrators automatically inherit any attributes from the Group and technically become children of the Group once it is completely registered. Attributes are defined for a Group the same way as an Individual.

A one-time use token can also be used in the identity session above. Party A and Party B (or Party B's parent) can exchange a one time use token in advance of the session that can be used by Party A to indicate only to allow trust to Party B once (or for a predetermined time). The one time key would need to be provided by Party B and can be used with other sources to create the confidence level. Party A would have configured their account in the service with the one time token.

The identity system will preferably also keep statistics and logs on usage patterns. This information can be used to identity possible fraudulent identity requests as well as possible stolen identity, which will allow the service to shut down, monitor, or affect the confidence level of certain users. For example if the system notes a certain ID badge has been given for many sessions where all other input sources have not been verified then it might surmise that this ID badge had been stolen and could either lock out the user, reduce the confidence given to this badge ID (making the badge useless but not the user account), and/or contact the user to verify the location of the badge and where it had been used.

The preferred embodiment of the invention, described above, provides a number of important advantages. For example, this preferred embodiment of the invention reduces the dependence of the identifier to have specialized equipment or expertise in order to make identification, and enables the person being identified to use additional means of identification (such as pin, password or challenge questions) without having to give this information to the identifier. The invention provides the identifier with the analog identification response giving them a score for the quality of the identification, and provides a method to calculate the quality of the identification. The invention provides a method for allowing the identifier to set the level of identity that needs to be reached, and provides a method for continually challenging the person to be identified for data until an identity quality is reached (i.e. use picture ID, PIN, and challenge questions).

As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

The present invention, or aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of assuring a person's identity, comprising the steps of:
a first party registering with an identity service and giving the identity service a first set of answers to a set of questions and additional identifying data; and
the identity service giving the first party identification information;
the first party establishing its identity with a second party including the steps of:
the first party giving the second party said identification information and a second set of answers to said set of questions;
the second party sending said identification information and said second set of answers to the identity service; and
said identity service analyzing said identification information and comparing said first and second sets of answers to determine an identification quality rating for said first party;
said identity service sending said identification quality rating to the second party; wherein:
the step of the first party registering with the identity service includes the steps of:
the first party creating an account with the identity service;
the first party putting personal information in said account;
the identity service sending to the first party a public key/private key pair for encrypting and decrypting messages;
the step of the first party giving the second party said identification information and the second set of answers includes the steps of said first party inputting said identification information and said second set of answers into a specified device;
the step of the second party sending said second set of answers and said identification data to the identity service includes the step of said specified device encrypting said second set of answers and said identification information using said private key, and sending the encrypted identification information and said encrypted second set of answers to the identity service; and
the step of said identity service analyzing said identification information and comparing said first and second sets of answers includes the step of the identity service computing a confidence level, t, according to the equation:
$$t = \frac{\overline{x} - {μ}_{0}}{\frac{σ}{\sqrt{n}}}$$
where μ₀ is a value representing a percentage of expected incorrect answers.

2. A method according to claim 1, wherein, if both parties have the ability to connect to the identity service, then the step of the first part establishing its identity includes the steps of:
the first party giving the second party said identification information;
the second party sending said identification information to the identity service;
the first party then contacting said identity service and sending a second set of answers to the identity service;
the identity service analyzing said identification information and comparing said first and second sets of answers to determine an identification quality rating for said first party, and sending said identification quality rating to the second party.

3. A method according to claim 1, wherein the first and second parties may be group entities, parent entities, child entities, or devices.

4. A method according to claim 1, wherein the computing step includes the step of computing said value, t, each time the first party answers one of said questions.

5. A method according to claim 1, wherein the second party specifies a level of trust the first party needs to attain.

6. A method according to claim 1, wherein the identification information is stored in a secure data vault.
